(19) United States
(12) Patent Application Publication
(10) Pub. No.: US 2005/0216639 A1
(43) Pub. Date: Sep. 29, 2005

(54) Mobile memory device with integrated applications and online services

(76) Inventors: Craig Sparer, Boynton Beach, FL (US); Howard Fried, San Leandro, CA (US); Dale L. Johnson, Redwood City, CA (US); Stewart I. Alpert, Glendale, CA (US); John Carosella, Los Altos, CA (US); Gregory A. Swanson, San Jose, CA (US)

Correspondence Address: PILLSBURY WINTHROP SHAW PITTMAN LLP, P.O. BOX 10500, MCLEAN, VA, 22102, US

(21) Appl. No.: 10/900,013

(22) Filed: Jul. 26, 2004

Related U.S. Application Data
(60) Provisional application No. 60/490,024, filed on Jul. 24, 2003.

(51) Int. Cl. G06F 12/00

(52) U.S. Cl. 710/305; 711/100

(57) ABSTRACT

A system, method and apparatus for integrating onto a mobile memory device, data and integrated software used to access and manipulate the data. The mobile memory device is accessible from any suitable computing device adapted to receive a universal port connector such as USB or Firewire. The integrated software is capable of connecting a networked computing device to a central server in order to synchronize the data stored on the mobile memory device with copies of the same data stored on the server. Access control is implemented by the integrated software to identify authorize users and grant appropriate access rights to the data stored on the mobile memory device. The integrated software provides a plurality of tools for organizing, manipulating and sharing data including: calendaring, messaging, file management, file browsing, Internet access, database management and communications.

### CROSS-REFERENCE TO RELATED APPLICATIONS

This application claims the benefit of priority from U.S. Provisional Application No. 60/490,024, filed Jul. 24, 2003, which is fully incorporated herein by reference for all purposes.

### BACKGROUND OF THE INVENTION

1. Field of the Invention

Generally, the present invention relates to collaborative computing and communications. More specifically, the present invention relates to networks of computing systems and a variety of transportable memory storage devices used for secure, transportable and distributed collaborative computing and communications.

2. Description of the Related Art

Since the creation of modem electronic computer systems, it has been important for humans to be able to upload, download, install, transfer, move, update, copy and otherwise manipulate digital data to, from and between computing devices and other computing device users. Historic ally this has been accomplished using various network connection methods or through the use of removable storage media, such as, disk packs, tape cassettes, tape cartridges, floppy disks, CD-R/W, DVD-R/W, external hard drives, and other similar devices. More recently, portable devices with large available memory, such as removable flash drives, memory sticks, pen-drives, removable hard drives, mobile phones, personal digital assistants, etc., represent technical tools by which a human can move large quantities of digital data easily from device to device.

As an example, a typical removable flash drive today is capable of storing in excess of 2 GB of data, with versions exceeding 8 GB planned to enter the market in the near future. This transportable memory device is simply coupled to the accompanying interface, for example a USB port, on any compatible computer. In the example of a USB port, once the memory device inserted, a drive icon shows up in the location listing as a memory device. The computer operator then simply clicks on the icon to open it and begins working with the digital data stored on the USB memory device. Thus, the typical transportable memory device is simply used for as a data transport device.

Additionally, in today's networked computing environment, it has become desirable and commonly available to have the ability to work electronically in a collaborative fashion, using products such as Groove, MS Exchange, MS IIS, MS SharePoint, Lotus SameTime, Lotus Notes, IBM Domino and others. These typical applications allow collaboration through other applications, including instant messaging, file and bookmark sharing, contact sharing, and other functions. However, these tools are typically loaded onto the host computer, such as a desktop or laptop, and require varying levels of expertise to acquire, install, configure, administer and maintain. These tools also typically require a correspondingly complex infrastructure. These requirements severely limit the collaborative computer users' ability to access, use and transport their applications and data easily, quickly and securely from any computer or communications device.

### SUMMARY OF THE INVENTION

The present invention comprises a storage device that stores executable client software and data, and the storage device may be coupled with a computing device, such as a personal computer, personal digital assistant (“PDA”), cellular telephone, etc. The storage device may be a portable pen drive including flash memory, or other peripheral memory device, for example. Data and software on the storage device may be securely stored, and may require access using security features such as a biometric scanner or password protection.

The storage device may be coupled to the computing device through a universal port connector such as a USB port or Firewire, for example. The software on the storage device, when the storage device is coupled to the computing device, may be executed by the computing device directly from the storage device without requiring software installation of the client software on the computing device, and without requiring administrative access rights on the computing device. When the client software is invoked for the first time on the computing device, the storage device may install an auto launch utility on the computing device, which automatically invokes the client software the next time the storage device is inserted into the computing device.

The software on the storage device may manipulate and update data in the computing device memory, or the operator of the computing device may perform operations that update data in the computing device memory using software not on the storage device. In the latter case, the computing device may store in memory on the storage device any data stored in the computing device memory that is related to software applications. If the operator updates related data when the storage device is not coupled to the computing device, then software on the storage device, upon coupling of the storage device with the computing device, may request that the updated data be transferred to the storage device memory to synchronize the data stored in the storage device with the data stored in the computing device.

The computing device may be coupled to a network of other computing devices (such as the Internet, a WAN, a LAN, etc.), including file and application servers. The application server(s) may provide an online service having applications including document management, document sharing, directory, activity sharing such as calendar sharing, instant messaging, electronic mail, etc. The application server(s) may include server software for communicating via the computing device with the client software on the storage device. The client software on the storage device may provide complementary services such as document management, document sharing, calendar, email, contact management, instant messaging, etc. The software on the storage device may use a local data file on the storage device employing MS Access or DBase to store information for these applications.

The client software on the storage device loaded on the computing device may connect directly to an online service server on the network using a secure network protocol including for example, TCP/IP based protocols. A unique identifier may be stored on the storage device, allowing the storage device to be employed as a factor of user authentication. The server associates the identifier with the storage device owner's login I.D. When the client software connects to the server, the client software sends the user's login I.D., password and the storage device unique identifier. The server checks whether the login I.D. matches the storage device identifier. If so, the server then verifies the password. If so, the server establishes a session with the client software. If not, access is denied. In this online mode, the local data file on the storage device is kept synchronized with the related data stored on the server's database. If the computing device to which the storage device is coupled is offline, then the local data file in the storage device may be updated when the storage device is next coupled to a computing device that is networked with the associated server. Conversely, updated data on the storage device may be “pushed” out to the corresponding server when the storage device is connected to the online service.

According to an embodiment of the invention, the network may be a secure network having online service members given rights to configure applications on the online service. Such applications include, for example, shared services such as contact management, file sharing, mobile text messaging, email, calendar and bookmarks. An online service member may establish a group of online service members and give members of the group access rights to particular services. For example, an online service member may set up a first group of members who have read/write access to his calendar, a second group that only has read access to his calendar, a third group that has read access to his contacts information, and other groups with access to selected files, and so on. Shared access may be regulated through the use of access control lists. Members of the group so authorized may place files in a common logical location (i.e., a library), where such files are visible and accessible to members of the group. A file stored on the memory device may be uploaded to a server memory associated with the online service when the storage device is coupled to the network. A group member so authorized may store a file in the group library with only private access allowed to the member.

A member of the Group may gain sole rights to edit a file in the group library (referred to for convenience as “Check Out”). The file that is checked out by a member may be so indicated to all other members of the group when they view the library. The member who has checked out the file may download the file locally and operate on the file, save it, and then upload the file back into the group library, and relinquish control of the file (referred to for convenience as “Check In”). Each member of the Group may be made aware of the status of his local version of the file relative to the version of the file that is in the service, (e.g., synchronized with, older than, or newer than, the file that is in the service). A member of the group so authorized may also place URLs (Bookmarks) in the group Library, where the URLs are visible and accessible (e.g., through a web page) to all members of the group.

An online service member may also provide access to his shared services to a non-member, denoted a “guest,” either as part of a group or not. The guest may have access to the services through secure email.

The online service of the invention may permit tracking and maintaining a version history of a file, including a copy of each version of the file through its history of edits, a time/date stamp of who took action on the file and when, the ability to include, as part of the history, specific comments on the file associated with each action taken, by the member or guest taking the action, and the ability for members or guests so privileged to view the version history of the file, or portions thereof.

The online service of the invention may further selectively direct a message to one or more members or guests, by clicking on the representation of the file as viewed in the software, and selecting the feature, and indicating the desired recipients. Each recipient may receive a personalized and customized notification via email, automatically generated by the service, which contains information about the file that is visible to the member or guest through the software, and directs the member or guest via a URL to a web page that has been automatically generated by the service, through which the member or guest can download the file over an encrypted connection.

In particular as to guests who participate in a group, upon the addition of a file to a Group Library, or upon the updating of a file in a group library, each guest may receive a personalized and customized notification via email, (referred to for convenience as a Guest Digest) automatically generated by the online service application running on the server, indicating that the file has been added to the group library, which contains information about the file that may also be visible to member participants in the group. The email may provide a URL to a customizable web page that has been automatically generated by the service, through which the guest can download the file over an encrypted connection. Upon the addition or updating of multiple files in a group library by a group member, the Guest Digest may contain all new or updated files since the transmission of the last digest. The Guest Digest transmission rate may be settable by the creator/owner of the Group.

The online service of the invention may include a directory comprising directory entries. A member of the community of members may update his entry in the directory, where such updates are made available automatically to other members or guests as specifically and exclusively authorized by the member. In particular, a member may selectively make elements of his directory entry visible to other members or guests (e.g., restrict visibility of a cell phone number or birthday to an explicit set of other members or guests). A member's membership in the directory may be validated and authenticated through one or several mechanisms, including, for example: credit card system address verification; signature card submittal; or corporate letter-head authorization by a signing authority.

The online service of the invention may also include automatic controls that enable or disable service actions (e.g., sending a mobile message, instant message, email, or fax) available to a member that are dependent upon the contents of the recipient's directory entry (e.g., if the recipient has a mobile phone that accepts text messages configured in his directory entry, then the sender may see “Send a mobile message” as an enabled service for that recipient).

In another embodiment, the online service may further include automatic controls that enable or disable service actions (e.g., sending a mobile message, instant message, email, or fax) available to a member that are dependent upon the configuration of the sender's account capabilities (e.g., if the sender has an electronic fax service configured for his account, and the recipient has a fax number in his directory entry, then the sender may see “Send a fax” as an enabled service for that recipient).

The calendar service application of the invention may include daily, weekly, and monthly views. A member or guest may create meetings and appointments on the calendar, and invite other members or guests to the extent authorized. Meetings may be displayed on a member or guest's personal calendar if invited. An invitee can offer a response to the invitation that is visible to the inviter as part of the inviter' view of the meeting.

In another embodiment, the shared calendar service may further associate meetings and appointments with a group in which that the member or guest is a participant. Meetings associated with the group may be visible in the member or guest's view of the group calendar, even if the member or guest is not invited to the meeting. Meetings associated with the group may also be visible on appointment attendees' personal calendars. Details of the meeting associated with the group, including responses of the invitee, may also be visible to members of the group. Meetings associated with the group may also be “private,” and therefore visible only to the invitees, and on their respective group calendars. The calendar service may also allow a view of which time slots are not currently committed by a group member when inviting that group member to a meeting.

The calendar service may also establish a default time zone for a member or guest, a specific time zone for a meeting, and a specific time zone for a member, separate from that member or guest's default time zone, that the member or guest would like to associate with a meeting. The calendar service may display meetings on the daily, weekly, and monthly calendars that accurately reflect the time-zone selections and settings for the member or guest and the meeting.

The online service may also allow an inviter or other authorized member invited to a meeting to contract for a third-party service provider to deliver services to the invitees of the meeting, and to automatically place relevant information about accessing the services in their respective views of the meeting. Such third party services may include, for example, conference calling and voice-conference bridging, catering or internet-based video conferencing. Such third-party services may provide a web-based or browser accessible presentation capability and co-browsing. For all applications mentioned herein, the online service may communicate information to guests through automatically generated emails.

For groups, the online service may provide a method for selecting and viewing calendar items associated with the groups and a member or guest's personal calendar overlayed on the same calendar view.

The online service may further provide a method for integrating third-party services that have a time-sensitive component (e.g. overnight delivery services) such that relevant time events may be automatically placed and updated on a member or guest's calendar based on information provided by the third-party service (e.g., “A FedEx package from MEMBER X is due to arrive before 10:00 am” shows up on the appropriate date).

The online service also may allow a member or guest, who is so privileged, to examine a detailed record of all the files or bookmarks owned or checked out by himself or another member or guest, that the examining member has access to through the groups feature or other sharing means. Similarly, the online service also may allow a member or guest, who is so privileged, to examine a detailed list of all activities, meetings and appointments that the examined member has been invited to, that the examining member also has been invited to.

The online service may provide the ability for members to contribute comments to a running and ordered discussion topic, the ability for the contributions to be monitored and moderated, the ability for the contributions to include web pages and bookmarks, the ability for the contributions to be attached to web pages, wherein the ability for the discussion topic may be about a web page or defined collection of web pages in a manner that makes the web page or web pages an obvious part of the discussion set-up and contribution mechanisms. Ordered discussion topics can be linked to any shared items, including appointments, files, bookmarks, etc.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates an exemplary embodiment of a storage device;

FIG. 2 is a block diagram illustration of the functional elements in an exemplary embodiment of a storage device;

FIG. 3 illustrates an exemplary embodiment of the invention featuring storage devices and an Internet connected network of computing devices and servers;

FIG. 4 is a diagram illustrating the login protocol in an exemplary embodiment of the invention;

FIG. 5 is a screenshot showing a login dialog in an exemplary embodiment of the invention;

FIG. 6 is a diagram illustrating the protocol used to establish a messaging communications channel between a software client and a server in an exemplary embodiment of the invention; and

FIG. 7 is a diagram illustrating the protocol used to establish a bulk transfer communications channel between a software client and a server in an exemplary embodiment of the invention.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

System Overview

An embodiment of the system comprises a plurality of storage devices and a computer network including computing devices and servers. The storage devices may contain a variety of data including: user data, encrypted data, configuration data, identification data and application data. The storage devices may also contain software including client software, installation software, auto-launch utilities and authentication software.

Storage Device

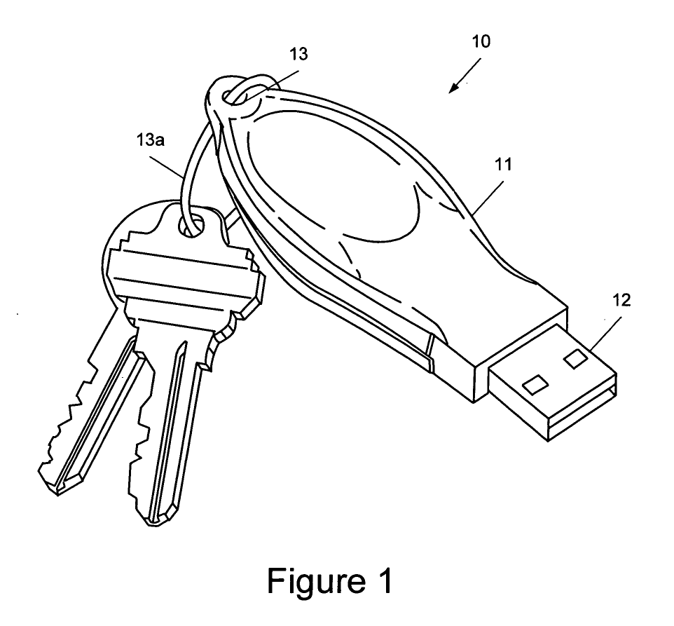

FIG. 1 illustrates a storage device 10 of an embodiment of the present invention. The storage device 10 comprises a housing 11; a universal interface/connector 12 on the housing 11 and configured to connect storage device 10 to a universal port such as USB, compact flash memory or SD card; and an internal memory device 14 (not shown) contained by the housing 11 and operatively coupled to the interface/connector 12. The housing 11 may be of a size and shape that can be comfortably held in a users hand.

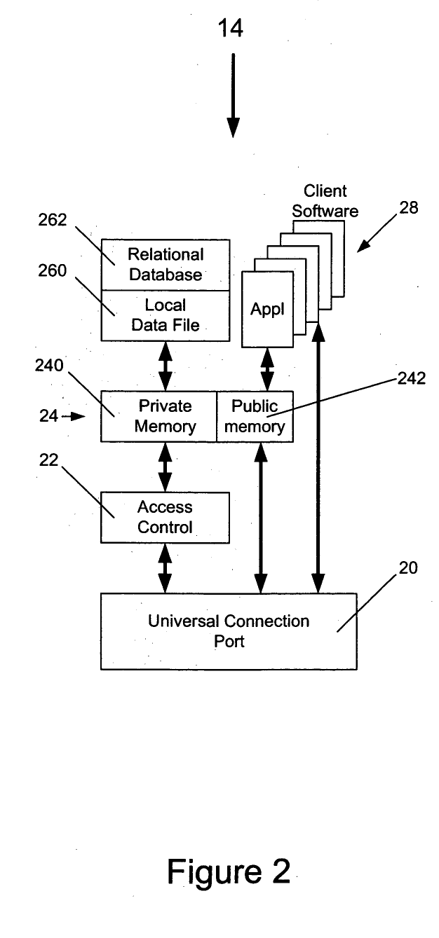

Referring to FIG. 2, in some embodiments of the invention the memory device 14 comprises a memory 24 such as a readable rewriteable dynamic memory. The memory device 14 further comprises a security device 22 enabling access to a private memory area 240 by password, biometric or other security mechanisms. The memory device 14 further comprises client software 28, a local data file 260 and a relational database 262. The memory device 14 stores a unique identifier that is used as a factor of identification and security policy enforcement.

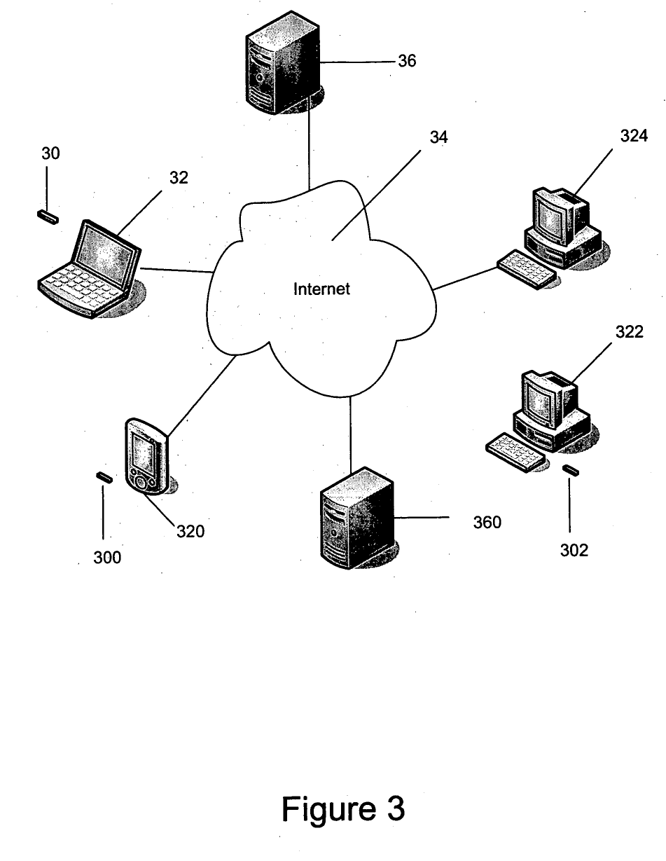

Referring now to the example embodiment of FIGS. 2 and 3, the client software 28 executes directly from the storage device 30 without the need for software installation on the computing device 32 or administrative rights on the computing device 32. In this example, the computing device 32 includes a USB port configured to receive the USB connector of the storage device 30. The computing device 32 recognizes the storage device 30 as a removable drive. In some embodiments, an auto launch utility from the storage device 30 is installed on the computing device 32 when the client software 28 is invoked for the first time on the computing device 32. Thereafter, the auto launch utility automatically invokes the client software 28 when the storage device 30 is inserted into the computing device 32.

The storage device 30 may also be connected to the computing device 32 using wireless protocols such as IEEE 802.11 and Bluetooth. Additionally, the storage device 30 may have a wireless phone such as GSM or CDMA built into it.

The present invention provides secure communication and sharing of information over a network using secure protocols, such as TCP/IP over the Internet 34. The present invention comprises a server computer 36 programmed to provide a plurality of services including document management, document sharing, directory, calendar sharing, activity sharing, instant messaging, electronic mail etc. In accordance with the principles of the present invention these services are integrated with the client software 28 that is invoked from the storage device 30 executing on the computing device 32. The client software provides applications such as calendar, email, contact management, instant messaging, etc. The client software uses a local data file 260 such as MS Access or Dbase to store information from these applications. The client software connects over a network using secure Internet protocols to the server computer 36. The connection is used to exchange information with the server computer 36. The client software 28 can also be used on a non-networked computing device 322.

Exemplary Architecture

Referring to FIGS. 2 and 3, an exemplary architecture suitable for implementing the systems and methods of the present invention, as illustrated in FIG. 3, comprises computing devices 32, 320, 322 and 324 and storage devices 30, 300 and 302. The storage devices 30, 300 and 322 are connected to the universal port connectors of the computing devices 32, 320 and 322, respectively. The computing devices 32, 320 and 322 execute the client software from the storage devices 30, 300 and 302. The computing devices 32 and 320 may be coupled through a network, such as the Internet 34 to a server computer 36. Additionally, a computing device 324 may use a browser to interact with the server computer 36.

Computing devices 32, 320 322 and 324 may include, for example, personal computers, notebook computers, Personal Digital Assistants and cellular telephones. The computing devices 32, 320, 322 and 324 may be standalone computing devices or may be connected to the Internet through, for example, a local area network. By way of illustration, the example network of FIG. 3 shows the computing device 322 with a storage device 302 operating in an offline mode without an Internet connection. The computing device 322 executes the client software 28 from the storage device 302. The computing device 322 uses the client software 28 to access the local data file 260.

Referring to FIGS. 2 and 3, client software 28 is a set of applications executed directly from the storage device 30, 300, 302. This client software 28 stores data in the local data file 260. This allows the client software applications to function without an internet connection.

The server computer 36 is coupled to Internet 34. The server computer 36 provides services to the client software 28. In some cases, the server computer 36 is used as a gateway to third party services 360. The server computer 36 comprises a set of application servers and a set of databases. In some embodiments, these databases are relational databases such as Oracle, DB2 and MySQL. Access control lists associated with user data may be stored with the user data. When a user requests an action on data (e.g., Read, update, delete, etc), the access control list is checked to see if the user has sufficient access rights to take the action. Where the user does not have sufficient access rights, the action is denied; otherwise, the action may be taken.

The client software 28 further comprises third party services integrated as features within the applications. An example of this would be a “print to Kinkos” option integrated into the file sharing application. When a user is in the file sharing application, the user can select the “print to Kinkos” option by mouse click, for example. In this example, the user is then presented with an electronic form that provides printing instructions to Kinkos. The server computer 36 may then transmit the file and instructions to Kinkos. Kinkos may print the file and deliver it according to the transmitted instructions. In this example, these features are implemented by coupling the computing devices 32 and 320 through a network, such as the Internet 34, to third party services 360.

In some embodiments, the storage device 30, 300 and 302 may also be used as a factor of user authentication. The storage device 30, 300 and 302 contains a unique identifier. The server computer 36 associates the unique identifier with a user's login ID. When the client software 28 connects to the server computer 36, the client software 28 may send the user's login ID, password and the unique identifier of the storage device 14. The server computer 36 may check to see if the identifier is associated with the user's login ID and, if an association exists, the server computer 36 checks the validity of the password. If the password is valid, the server computer 36 may establish a session with the client software 28. If the identifier is not associated with the user's login ID or the password is invalid, the user may be denied access.

In some embodiments, the local data file 260 on the storage device 30 and 300 stores a local copy of the user's data. This local data file 260 may be synchronized with the user's data that is stored in one or more databases on the server computer 36. When data accessible to the user is changed on the server computer 36, a copy of that data may be sent to the client software 28 on the storage device 30 and 300. The client software 28 subsequently updates the local data file 260.

Conversely, when data in the local data file 260 is changed locally, the client software 28 sends a copy of that data to the server computer 36. For example, where a storage device 302 is connected to a computing device 322 that does not have an internet connection, then the changes to the local data file 260 are queued on the storage device 302. These changes are sent to the server computer 36 the next time the client software 28 connects to the server computer 36 (i.e., synchronization occurs).

Exemplary Login Protocol

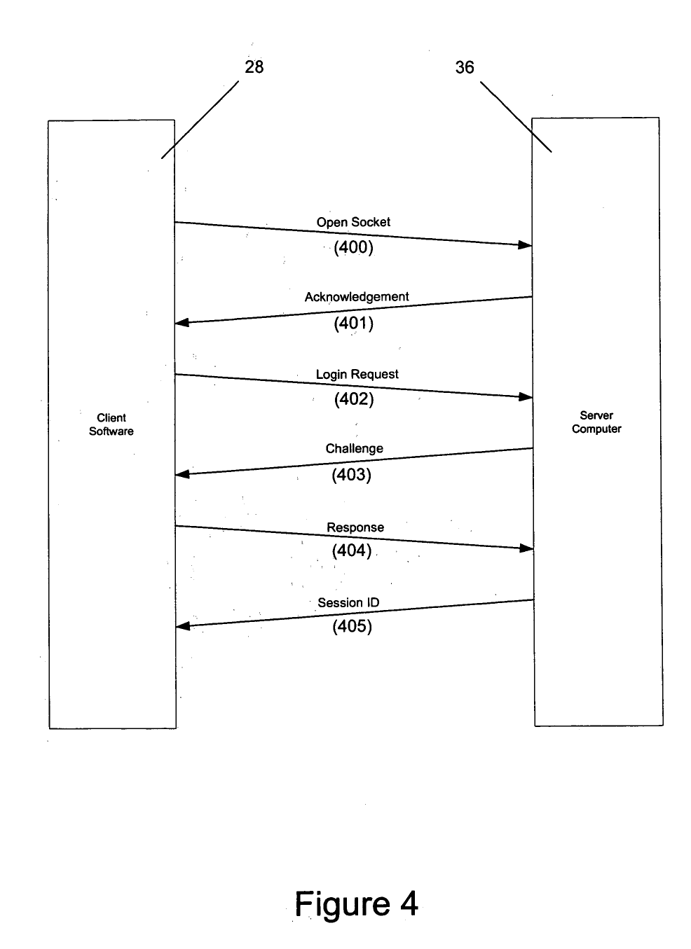

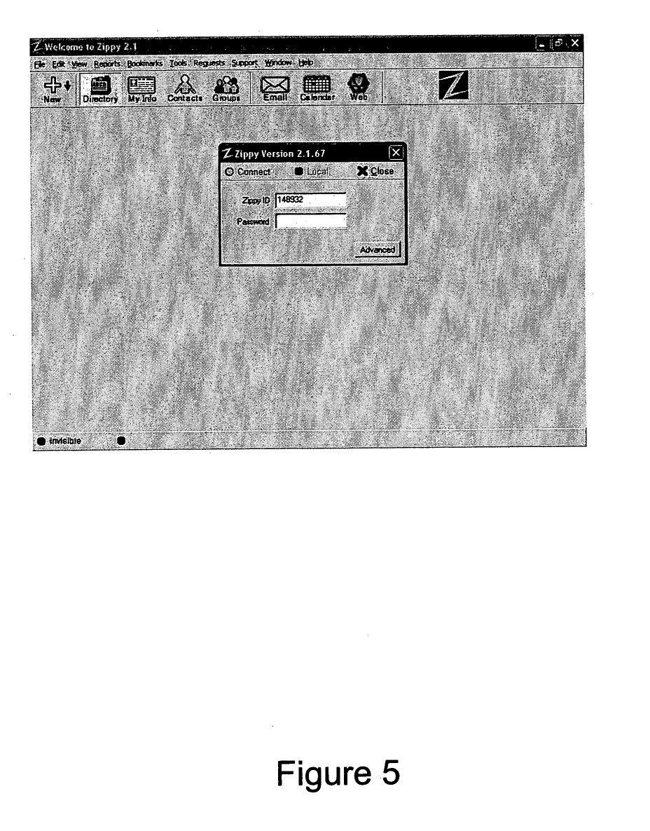

Referring now to FIGS. 2, 3, 4 and 5, an exemplary login protocol is shown in FIG. 4. In some embodiments, a user must perform a login to a computing device 32 before the client software 28 can engage in transactions with the server computer 36. In the example of FIG. 4, the login establishes a session ID that the client software 28 uses to log into the server computer 36. When the client software 28 is executed on the computing device 32, a login screen may appear, as shown in FIG. 5. The user may then enter a login id and password. Subsequently, the client software 28 may initiate the opening of a TCP/IP socket or other secure connection 400 to the server computer 36. The server computer 36 may send an acknowledgment 401 to the client software 28. The client software 28 may then request a login 402 and pass the login ID to the server computer 36. The server computer 36 may respond with a challenge 403 to the client software 28. The client software 28 may formulate a response based on the password and cause computer 36 may establish a session for the user software 28 in the server computer 36. The server computer 36 sends the session key 405 to the client software 28. If the response is not valid the server computer 36 sends an error message (not shown) to the client software 28. Having established a connection to the server computer 36, the client software 28 may maintain the connection for the duration of the session to facilitate communications including message requests by the client software 50. A standard message protocol is used for communications through this channel.

Exemplary Standard Message Request Protocol

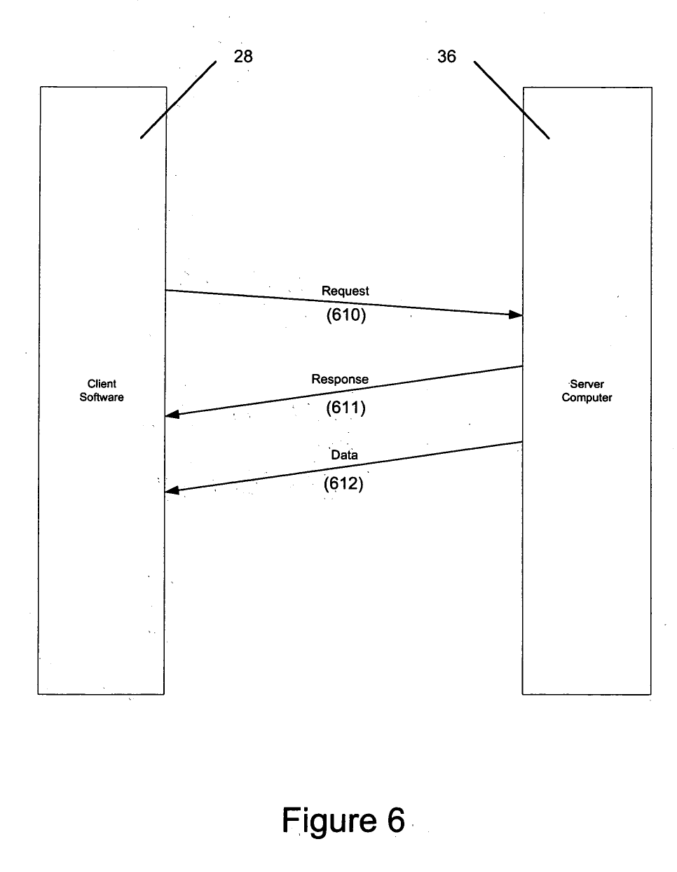

Referring now to FIGS. 2, 3 and 6, an exemplary standard message protocol is shown in FIG. 6. In some embodiments, the standard message request protocol is used to send small-sized messages between the client software 28 and the server computer 36. These messages are in the form of a request 610 and a response 611 and may be followed by a transfer of data 612. These messages are communicated over the main connection between the client software 28 and the server computer 36. Requests 610 that may be sent from the client software 28 to the server computer 36 include requests for the login ID and session key. If the session key is invalid then the server computer 36 will not process the message. If the session key is valid, then the server computer 36 may process the message and send a result as a response 611 to the client software 28. The server computer 36 processes the message by sending it to an appropriate application server 360 including, for example, instant messaging servers, document management servers, calendar servers and third party service gateways (such as Cingular for mobile messaging, Kinkos for printing, J2 for fax, etc.).

Standard message protocol messages may be used to gain access to services provided by the server computer 36 including instant messaging, document sharing, calendar sharing, email, etc. These messages can also be used to gain access to third party services including FAX service via J2.com, printing service at Kinkos, conference calling service via Qwest, etc. The client software 28 may gain access to these third party services through, for example, the server computer 36 and by connecting directly to the third party services over SSL or any similar secure connection.

The standard message request protocol may also be used by the server computer 36 to send messages to the client software 28. These messages may be used by the server computer 36 for purposes that include real time communications and updates to the client software 28.

Exemplary Bulk Transfer Request Protocol

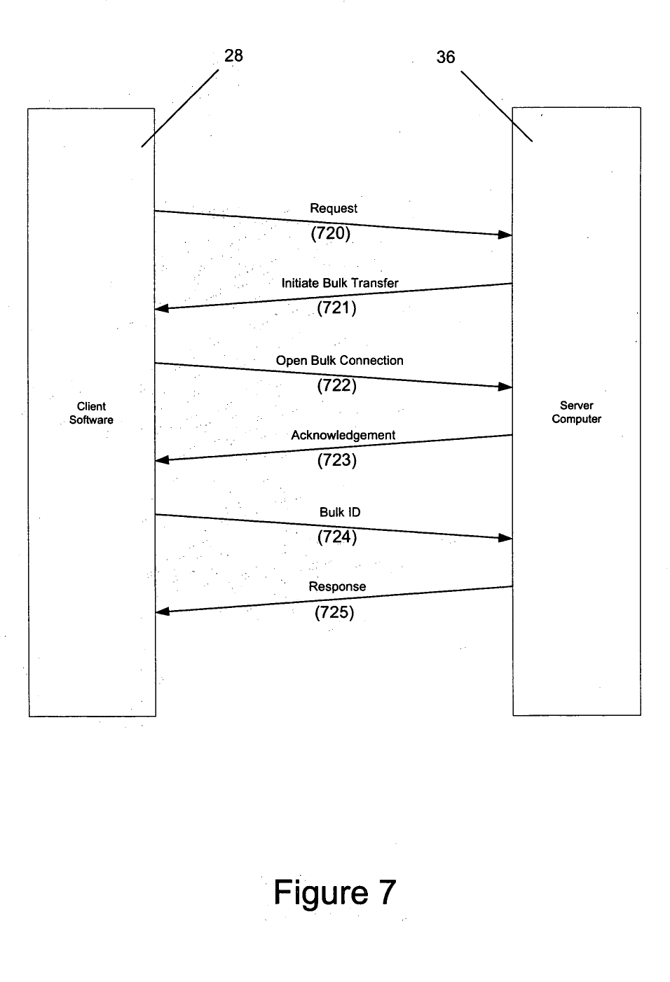

Referring now to FIGS. 2, 3 and 7, an exemplary bulk transfer protocol is shown in FIG. 7. In some embodiments, large volumes of data may be transferred between the client software 28 and the server computer 36 using the bulk transfer request protocol. In the example, the bulk transfer request protocol may be used for messages whose size is greater than 4 Kbytes. In some embodiments, a session created using the bulk transfer protocol may be terminated after data transfer is completed. An example of the bulk transfer request protocol is a file download request. The client software 28 makes a file download request 720 over the main connection to the server computer 36. The server computer 36 processes the request and sends a response back to the client software 28 requesting the client software 28 initiate a bulk transfer 721. The client software 28 opens a bulk channel connection 722 with the server computer 36. The server computer 36 sends an acknowledgement 723 to the client software 28 over the bulk channel connection. The client software 28 sends the bulk transfer request ID 724 to the server computer 36. The server computer 36 then transfers the response 725 over the bulk channel connection.

1. A mobile memory device comprising
a portable housing,
non-volatile memory within the portable housing having stored therein a plurality of applications,
an interface adapted to permit the memory to be coupled to a host computing device through a peripheral interface, and
client software resident in the memory and capable of causing the applications stored in the non-volatile memory to execute on the host computing device without those applications being installed on the host computing device.

2. The mobile memory device of claim 1 wherein the interface is USB.

3. The mobile memory device of claim 1 wherein the interface is firewire.

4. The mobile memory device of claim 1 wherein the interface is wireless.

5. The mobile memory device of claim 1 further including an auto launch utility for installing invocation software on the host computing device for automatically launching the client software upon the coupling of the interface to the host computing device.

6. The mobile memory device of claim 1 further including a security interface for validating a user's authorization to access at least one of the plurality of applications.

7. The mobile memory device of claim 6 wherein the security interface is a computer program.

8. The mobile memory device of claim 1 wherein a portion of the memory is adapted for storage of a user's data and the data can be accessed by any associated program without the data being stored on the host computing device.

9. A method for executing applications stored on a mobile memory device capable of being coupled to a peripheral interface of a host computing device, the mobile memory device having a memory and a peripheral interface adapted to be coupled to a host computing device, the method comprising the steps of
storing in the memory a plurality of programs,
coupling the mobile memory device to a host computing device, and
executing a client program resident on the memory device adapted to permit the execution of at least two of the plurality of programs without installing the programs on the host computing device.

10. The method of claim 9 further including the step of validating a user's access to the plurality of programs.

11. The method of claim 9 further including the step of storing a user's data in the memory,

12. The method of claim 11 further including the step of validating a user's access to the data stored in the memory.

13. The method of claim 9 further including the steps of
connecting the host computing device to a network having at least one network service available, and
validating a user's authorization to access the at least one network service.

14. The method of claim 11 further including the step of
causing the data stored in memory to be accessed by an application program resident on the host computing device.

15. The method of claim 11 further including the step of causing the data stored in memory to be accessed by an application program resident on the memory device.

16. A data sharing system comprising
at least one server having stored thereon data capable of being remotely accessed,
at least one memory device comprising a portable housing, non-volatile memory within the portable housing having stored therein a plurality of applications, an interface adapted to permit the memory to be coupled to a host computing device through a peripheral interface, and client software resident in the memory and capable of causing the applications stored in the non-volatile memory to execute on the host computing device without those applications being installed on the host computing device, and
a network connection between the host computing device and the server for permitting remote access of the data on the server by the applications on the memory device.

17. The data sharing system of claim 16 wherein the data on the server is an application program.

18. The data sharing system of claim 16 further comprising program code for validating user authority to access the data on the server.

19. The data sharing system of claim 16 wherein both the server and the memory device further comprise memory space for storage of a user's data.

20. The data sharing system of claim 19 further comprising program code for synchronizing a user's data stored on the server and the memory device.
